(19) United States
(12) Patent Application Publication
(10) Pub. No.: US 2006/0075174 A1
(43) Pub. Date: Apr. 6, 2006

(54) METHOD AND APARATUS FOR PLUG-AND-PLAY WEBSERVER

(75) Inventor: Cory Thang Vuong, San Diego, CA (US)

Correspondence Address: CORY THANG VUONG, PO BOX 910096, SAN DIEGO, CA, 92191-0096, US

(73) Assignee: Mr. Cory Vuong Thang Vuong, San Diego, CA (US)

(21) Appl. No.: 10/906,094

(22) Filed: Feb. 3, 2005

Related U.S. Application Data
(60) Provisional application No. 60/522,492, filed on Oct. 6, 2004.

(51) Int. Cl. G06F 13/00

(52) U.S. Cl. 710/302

(57) ABSTRACT

A system, method and computer program for an apparatus is described. An apparatus is a very convenient, plug-and-play, ultra small, smart device that lets the end-users to host their websites at computer peripheral port. When said device is plugged in one of the computer peripheral ports: Universal Serial Bus (USB), Secure Digital Input and Output (SDIO), Compact Flash (CF), Cardbus, Peripheral Component Interconnect (PCI), PCI-Express and ExpressCard; it shall function as a dedicated web hosting device powerful and robust enough to handle web hosting functions for Personal Home Page, File Transfer Protocol (FTP) Files Server, Streaming media, Common Gate Interface (CGI) scripts, Active Server Pages, or Game Server.

### CROSS-REFERENCE(S) TO RELATED APPLICATIONS

This application is related to solely-owned, U.S. Patent Application Ser. No. 60/522492, filed Oct. 6, 2004 on behalf of inventor Cory Vuong, entitled HOSTSTICK DONGLE PLUG-AND-PLAY WEB SERVER, which is incorporated in its entirely by reference herein by reference for all purposes.

### TECHNICAL FIELD OF THE INVENTION

The present invention relates to internet communications at computer peripheral ports and, more particularly, an apparatus capable of operating as a dedicated web hosting device when is plugged in one of computer peripheral ports such as: Universal Serial Bus (USB), Secure Digital Input and Output (SDIO), Compact Flash (CF), Cardbus, Peripheral Component Interconnect (PCI), PCI-Express and ExpressCard, etc.

### BACKGROUND OF THE INVENTION

The interfaces Universal Serial Bus (USB), Secure Digital Input and Output (SDIO), Compact Flash (CF), Cardbus, Peripheral Component Interconnect (PCI), PCI-Express and ExpressCard are described in specifications available over the Internet at www.usb.org, www.sdcard.org, www.compactflash.org, www.pcmcia.org, www.pcisig.com, www.expresscard.org.

The Air interfaces WiMAX, Ultra Wide Band (UWB), Code Division Multiple Access (CDMA), Global System for Mobile Communication (GSM), and General Package Radio Service (GPRS) are described in specifications available over the Internet at www.ieee.org, www.cdg.org, www.etsi.org.

Free webpage services such as Geocities which are very convenient but also have drawbacks. The first drawback is the lack of space. Most free services will limit the amount of storage space users can use which will pose a problem if they plan on having multimedia contents such as audio and video clips. Another drawback is that all of the free webpage services require users to place their banner ads on each page of their website. Some sites implant an advertising menu bar on their website instead of banners, which isn't much better. Even worse is the trend toward pop up ads. The final and most important drawback of these services is that users have domain names that are difficult to remember and find.

For larger websites with users' own domain names, most users pay web hosting services to run their website. Basic packages are relatively costly for monthly services may range up to a couple hundred dollars and still get downtime whether it'll be a few minute or a few hours at a time. It's just a fact of the business—downtime is inevitable. The better hosts have less down time, but this also means they cost more money.

Another disadvantage for paid web host is a customer's website will reside on a server that has hundreds to thousands of other websites on it. For most situations, putting several websites on one web server is acceptable, but problems usually arise when the web host gets cheap and overloads the web server with way too many websites. This means that the customer's website will slow down tremendously if another website on the same server gets really busy.

### GLOSSARY

Unless otherwise noted, or as may be evident from the context of their usage, any terms, abbreviations, acronyms or scientific symbols and notations used herein are to be given their ordinary meaning in the technical discipline to which the invention most nearly pertains. The following terms, abbreviations and acronyms may be used in the description contained herein:

Definition List 1

| Term | Definition |
|---|---|
| ARM | Architecture Microprocessor |
| BT | Bluetooth |
| CDMA | Code Division Multiple Access |
| CF | Compact Flash |
| CGI | Common Gate Interface |
| CPU | Central Processing Unit |
| CRC | Cyclic Redundancy Check |
| DMA | Direct Memory Access |
| DNS | Domain Name Service |
| ExpressCard | PCMCIA developed the ExpressCard standard to |
| | carry forward the benefits of ‘plug-in’ I/O cards |
| | to the next generation of personal computing devices. |
| FIFO | First-In First-Out |
| FLASH | Also known as Flash ROM. A form of EPROM |
| | based upon conventional UV EPROM |
| | technology but which is provided with a mechanism |
| | for electrically pre-charging selected sections |
| | of the capacitive storage array, thereby |
| | electively “erasing” all capacitive |
| | storage cells to a known state |
| FTP | File Transfer Protocol |
| GPRS | General Package Radio Service |
| GSM | Global System for Mobile Communication |
| GNU | GNU is a recursive acronym for “GNU's Not |
| | UNIX”. GNU is an operating system of Linux. |
| SPA | Shared Panel Application |
| HTTP | Hyper Text Transfer Protocol |
| IDE | Integrated Development Environment |
| I/O | Input and Output |
| IRQ | Interrupt Request |
| IMAP | Internet Message Access Protocol |
| IC | Integrated Circuit |
| IrDA | Infrared Data Association |
| IEEE | Institute Electrical and Electronics Engineering |
| LED | Light Emitting Diode |
| MIPS | Million Instruction Per Second |
| OSC | Crystal Oscillator |
| PC | Personal Computer |
| PCB | Printed Circuit Board |
| PCI | Peripheral Component Interconnect |
| PCMIA | Personal Computer Manufacturer Interface Adapter |
| Perl | Practical extraction and report Language |
| PLL | Phase Lock Loop |
| POP3 | Post Office Protocol Version 3 |
| PPM | Position Pulse Modulation |
| RISC | Reduced Instruction Set Computer (or Chip) |
| ROM | Read-Only Memory |
| SD | Secure Digital |
| SDIO | Secure Digital Input/Output |
| SMTP | Simple Mail Transfer Protocol |
| SoC | System On Chip |
| SPA | Shared Panel Application |
| SPI | Serial Peripheral Interface |
| SRAM | Static Random Access Memory |
| USB | Universal Serial Bus |
| UWB | Ultra Wide Band |
| VLIO | variable latency I/O |
| WBCP | Web-Based Control Panel |
| WCDMA | Wideband Code Division Multiple Access |
| WiMAX | A Wireless Networking Standard 802.16 |
| WLAN | Wireless Local Area Network |

### BRIEF DESCRIPTION (SUMARY) OF THE INVENTION

A need therefore exists for a mini plug and play apparatus that provides dedicated Web Hosting functions without the above-described disadvantages and problems.

A method for a mini plug and Play apparatus to operate as a Web Hosting device when it is plugged in one of host computer peripheral ports such as: Universal Serial Bus (USB), Secure Digital Input and Output (SDIO), Compact Flash (CF) , Peripheral Component Interconnect (PCI), PCI-Express, Cardbus, and ExpressCard.

According to the invention, techniques are provided for a mini Plug and Play apparatus to function as a dedicated Web hosting device. These techniques are preferably implemented by combining a high-performance low-power CPU with a variety of different system peripherals such as Memories (SRAM/SDRAM/ROM/FLASH), Direct Memory Access (DMA) and memory controllers, clocks and power controllers, USB, SDIO, CF, Cardbus, PCI/PCI Express, ExpressCard, companion Integrated Circuit (IC) chips and codes.

An exemplary use for the apparatus of the present invention is to simplify the development of the following companion IC chip such as: USB-to-Ethernet, SDIO-to-Ethernet, Cardbus-to-Ethernet, PCI-to-Ethernet, CF-to-Ethernet, and ExpressCard-to-Ethernet. The IC chip can be mounted to a small Printed Circuit Board (PCB). Such an approach can readily be adapted to other interfaces such as the IEEE 1394 (firewall), as well as other networking types of approaches, such as token ring or higher speed wireless adapters.

An integrated circuit (IC) employing the techniques of the present invention may be included in a system or subsystem having electrical functionality. Example systems may include general purpose computers; telecommunications devices such as: Cellular phones, Pocket PC, wireless Bluetooth, Wireless Ultra Wide Band (UWB), Wireless Local Area Network (WLAN), WiMAX, General Package Radio Service (GPRS), and Code Division Multiple Access (CDMA). It is within the scope of the invention that such systems would benefit substantially from technique(s) of the present invention.

Other objects, features, and advantages of the invention will become apparent in light of the following description thereof.

### BRIEF DESCRIPTION OF THE DRAWINGS

Reference will be made in detail to preferred embodiments of the invention, examples of which are illustrated in the accompany drawings. The drawings are intended to be illustrated, not limiting. Although the invention will be described in the context of these preferred embodiments, it should be understood that it is not intended to limit the spirit and scope of the invention to these particular embodiments. Certain elements in selected ones of the drawings are illustrated not-to-scale, for illustrated clarity. Often, similar elements throughout the drawings are referred to by similar references numerals. For example, the element 200 may be similar in many respects to the element 300 in another figure.

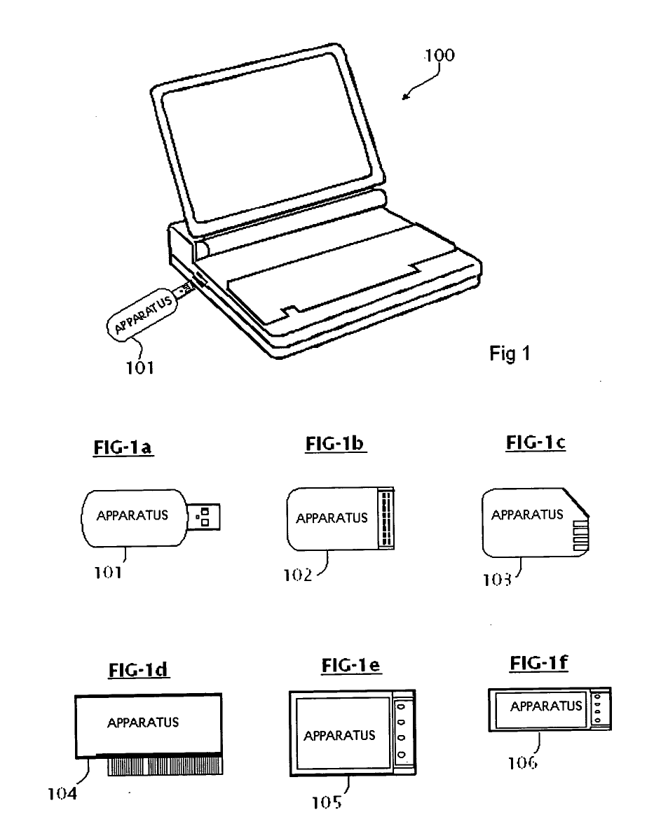

(1) FIG. 1a is a pictorial illustration of an USB apparatus used in a discussion of the prior art.

(2) FIG. 1b is a pictorial illustration of a CF apparatus used in a discussion of the prior art.

(3) FIG. 1c is a pictorial illustration of an SDIO Apparatus used in a discussion of the prior art.

(4) FIG. 1d is a pictorial illustration of a PCI Apparatus used in a discussion of the prior art.

(5) FIG. 1e is a pictorial illustration of a Cardbus Apparatus used in a discussion of the prior art.

(6) FIG. 1f is a pictorial illustration of an ExpressCard Apparatus used in a discussion of the prior art.

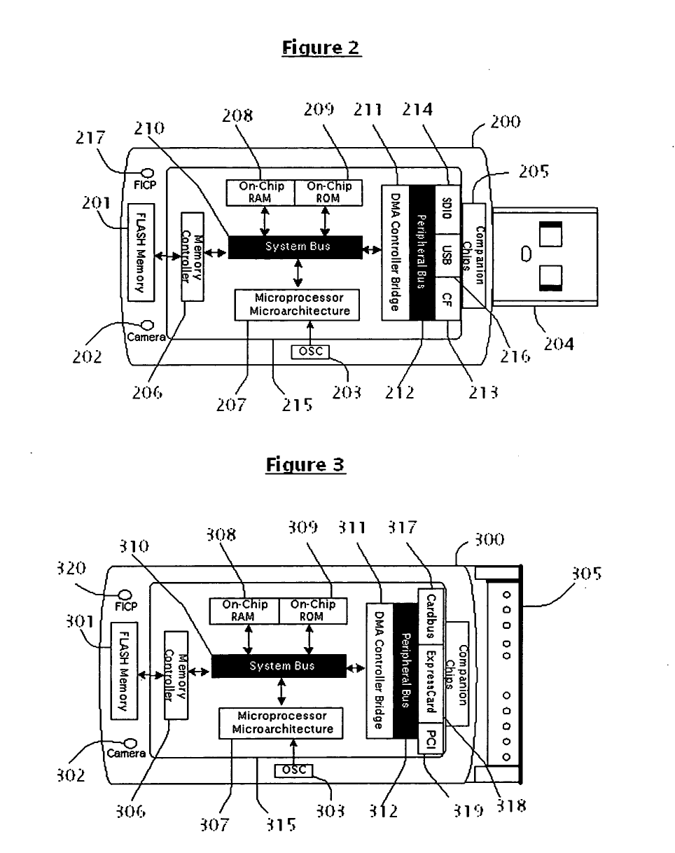

(7) FIG. 2 is a system block diagram of an USB apparatus, according to the invention

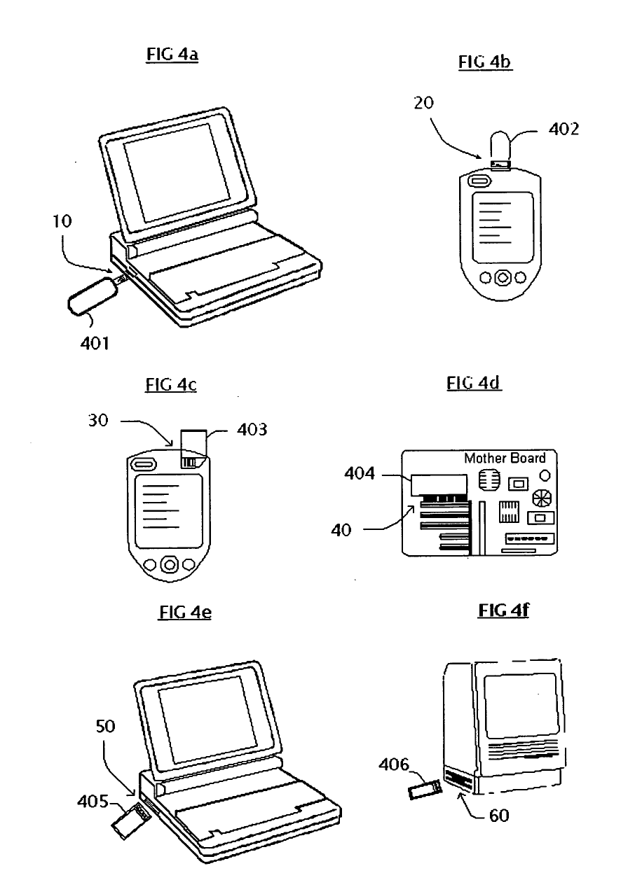

(8) FIG. 3 is a system block diagram of a Cardbus apparatus, according to the invention

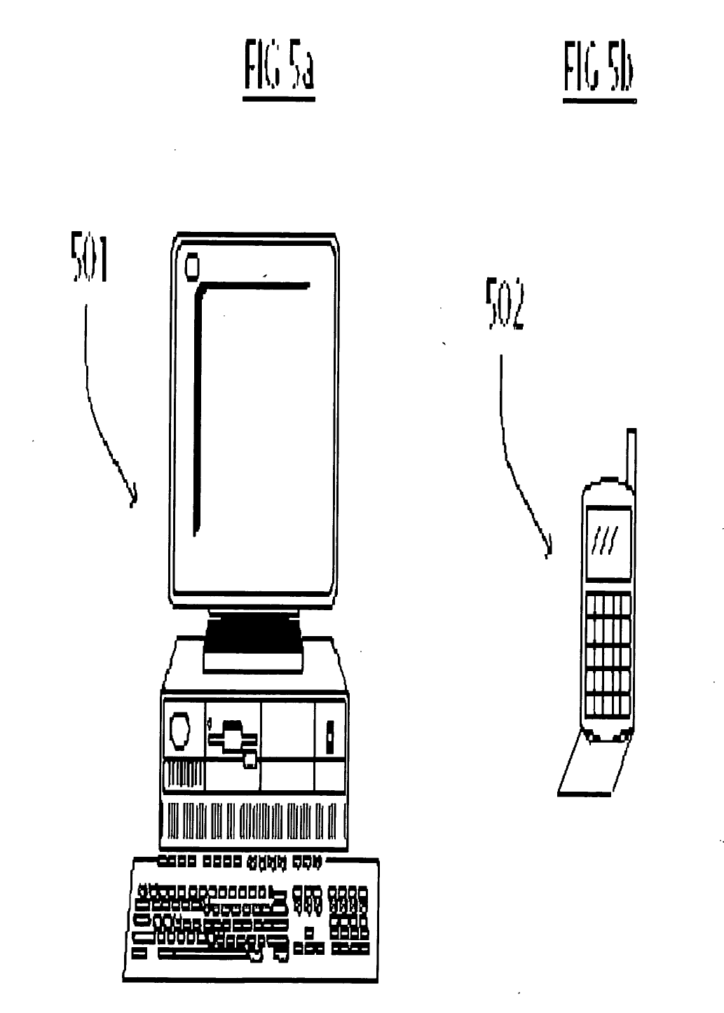

(9) FIG. 4a is an illustration of an USB apparatus plugging in a laptop's USB port, according to the invention

(10) FIG. 4b is an illustration of a CF apparatus plugging in a handheld computing device's CF port, according to the invention

(11) FIG. 4c is an illustration of an SDIO apparatus plugging in a handheld computing device's SDIO port, according to the invention

(12) FIG. 4d is an illustration of a PCI apparatus plugging in a computer motherboard's PCI port, according to the invention

(13) FIG. 4e is an illustration of a Cardbus apparatus plugging in a notebook computer's Cardbus port, according to the invention

(14) FIG. 4f is an illustration of an ExpressCard apparatus plugging in a computer's ExpressCard port, according to the invention

(15) FIG. 5a is an illustration of a general purpose computer incorporating the technique(s) of the present invention

(16) FIG. 5b is an illustration of a wireless telephone (cell phone) incorporating the technique(s) of the present invention

### DETAILED DESCRIPTION OF THE INVENTION

An apparatus is a plug and play, tiny network-enabled capability device that functions as a dedicated web hosting device 101 when is plugged in one of the following ports: USB 10, CF 20, SDIO 30, PCI/PCI-Express 40, Cardbus 50, and ExpressCard 60; the device contains a processor 215 that is a highly integrated system on a chip and includes a high-performance low-power CPU 207, with a variety of different system peripherals. The processor integrates the micro-architecture 207 with this peripheral set:
Memory Controller 206
Clock and Power Controllers 203
Universal Serial Bus Host/Client 216
DMA Controller and bridge 211
SDIO (Secure Digital Input and Output) 214
CF (Compact Flash) 213
Fast Infrared Interface Communication Port (FICP) 217
Memory (SDRAM 208/ROM 209/FLASH 201)
Companion IC Chips 205
Codes

### Memory Controller

The Memory Controller 206 provides glue-less control signals with programmable timing for a wide assortment of memory-chip types and organizations. It supports up to four SDRAM partitions; six static chip-selects for SRAM/SSRAM 208, Flash 301, ROM/SROM 209; it also supports interfaced buses for USB 216, SDIO 214, CF 213, Cardbus 317, PCI/PCI-Express 319, and ExpressCard 318.

### Clock and Power Controllers

The processor functional blocks are driven by high speed clocks that are derived from an OSC crystal 203 13 MHz or higher oscillation frequency. The OSC crystal 203 drives a core Phase Locked Loop (PLL) and a Peripheral PLL that produce selected clock frequencies to run particular functional blocks. Power management controls the transition between the turbo, run, idle, and sleep operating modes.

### Universal Serial Bus (USB)

The USB Client and master Modules 216 are based on the Universal Serial Bus Specification, Revisions 1.1, 2.0 or higher. It supports up to sixteen endpoints and it provides an internally generated clock. The USB Device Controller provides First-in First-out (FIFOs) with DMA access to or from memory.

### DMA Controller (DMAC)

The DMA Controller (DMAC) 211 provides prioritized channels to service transfer requests from internal peripherals 21 2 and up to two data transfer requests from external companion chips. The DMAC 211 is descriptor-based to allow command chaining and looping constructs. The DMAC operates in Flow-Through Mode when performing peripheral-to-memory, memory-to-peripheral, and memory-to-memory transfers. The DMAC 211 is compatible with peripherals that use word, half-word, or byte data sizes.

### SDIO (Secure Digital Input and Output)

The SDIO block 214 is based on the industry SDIO card specifications revisions 1.0 or higher. The SDIO bus 212 is a full speed I/O bus with low power consumption for a hot-plugged apparatus 403. The full-speed bus supports Serial Peripheral Interface (SPI), 1-bit SD and 4-bit SD transfer modes at the full clock range of 0-25 MHz. The SDIO apparatus' host interface block has SDIO bus interface, and with the following features:
Host clock rate variable between 0 and 25 MHz;
All SD bus modes are supported including SPI, 1 and 4 bit SD;
Allows to interrupt host in SPI, 1 and 4 bit SD modes;
Up to 10 Mbytes per second read and write rates using 4 parallel data lines;
Cyclic Redundancy Check CRC7 for command and CRC16 for data integrity-CRC checking optional in SPI mode;
Support direct read/write (IO52) and extended read/write (IO53) transactions;
Can execute IO52 while data transfer for IO53 is in progress;
Support read wait control operation;
Support suspend/resume operation;
The queues structure to allow the data transfers independent of IRQ processing time.

### Compact Flash (CF+) Block

The CF+ block 213 is based on the industry CF+ card specifications version 2.1 or higher. The CF+ block 213 has a feature known as Multiword Direct Memory Access or DMA to the True IDE Mode of operation. It allows a Compact Flash block to transfer data directly to and from the host system memory without passing through the host system microprocessor 207. Hence the words, Direct Memory Access. When a host system and Compact Flash block use DMA to access their information, the load placed upon the host system CPU 207 is reduced and the system transfers data faster. With the addition of the DMA feature, forward and backward compatibility is maintained and the CF+ block still provides a peak interface data transfer rate of 16 MB per second.

### Fast Infrared Interface Communication Port (FICP)

The Fast Infrared Communications Port (FICP) 217 operates at half-duplex and provides direct connection to commercially available Infrared Data Association (IrDA) compliant LED transceivers. The FICP is based on the 4 Mbps Infrared Data Association (IrDA) standard1 and uses four-position pulse modulation (4 PPM) and a specialized serial packet protocol developed for IrDA transmission.

### Memory

The processor Integrates Memory Controller 206 with Memory Bus 210 that including 16-bit, 32-bit, or 64-bit ROM 209, SRAM/SDRAM 208, FLASH 201, as well as USB 216, SDIO 214, CF 213, PCI,/PCI-Express 319, Cardbus 317, and ExpressCard 318 for added functionality and expendability. The external memory-bus interface for the processor supports SDRAM, synchronous, and asynchronous burst-mode and page-mode flash 201

memory, page-mode ROM 209, SRAM 208, variable latency I/O (VLIO) memory, PC Card, and Compact Flash expansion memory. Memory types are programmable through the memory interface configuration registers.

### Companion IC Chips

An exemplary use for the apparatus is to simplify the development of the following companion IC chips 205 such as: USB-to-Ethernet, SDIO-to-Ethernet, Cardbus-to-Ethernet, PCI-to-Ethernet, CF-to-Ethernet, and ExpressCard-to-Ethernet. The companion IC chip 205, CPU 207, and peripheral components can be mounted to a small Printed Circuit Mother Board (PCB). Such an approach can readily be adapted to other interfaces such as the IEEE 1394 (firewall), as well as other networking types of approaches, such as token ring or higher speed wireless adapters.

### Codes

The apparatus could very well fill the need for a solid, easy-to-manage, easy-to-use web hosting device that should be hot-plugged directly onto one of computer peripheral ports and ready for dedicated web hosting services. The device comprises Linux/GNU operating system ported to the MIPS/ARM CPU complete with custom Apache or other Web hosting codes. The device supports CGI, Perl scripting, e-mail via SMTP, POP3 or IMAP4, Domain Name Service, and a Shared Panel Application (SPA) program capable of cross drag-and-drop files between hosts such as Linux/Windows or Linux/Macintosh.

The apparatus is the perfect portable, mini Plug-and-Play Web hosting device for those making the transition from shared to dedicate web hosting to get the advantage that all the CPU power and Traffic Bandwidth are dedicated to user's own sites. Administration of the device is performed via the Web-Based Control Panel (WBCP) that guides end-user through Host Name, System Administration functions, an Administrator (root) password, Public the web pages, and some basic access rights for a user.

For web publishing, there's a built in, hosting-side, page builder that is user-friendly application for the end-users. One can also use Netscape Composer or other web page development tools such as Microsoft FrontPage or Page Mill to create web sites. Once complete, web pages can be uploaded into the web hosting device via Web-Based Control Panel (WBCP) application.

With custom coding supported, The device has strong functionality in:
Management
Security
High Performance and Scalability
Applications Compatibility
Web page http authoring and Website construction
Automated DNS zone management

### Management

The Web-Based Control Panel (WBCP) is a graphical user interface application that allows end-users to create separate user accounts for restricted access and configuring the web hosting device. WBCP application is enhanced with the look-and-feel, easy access to documentation, files and Browser-based. When the device is plugged in one of the computer peripheral ports (USB 10, CF 20, SDIO 30, PCI/PCI-Express 40, Cardbus 50, and ExpressCard 60); WBCP application shall be popped up automatically on computer's screen and is ready for system administration tasks.

### Security

The apparatus 200 has built-in security features available to the individuals and enterprises from unwanted attacks and undetected vulnerabilities. The built-in security feature restricts users to low privilege access to a well-defined partition of the file system and prevents public clients to access to the apparatus' files and services that they are not entitled to.

### High Performances and Scalability

The apparatus 200 is architected for extended scalability, efficiency, performance and functionality. It is designed for dedicated web hosting services with a variety of configurations. It is extremely versatile in handling volume transactions and high burst traffic. The apparatus 200 can serve around 100 web page requests a second (i.e., greater than 8 million hits a day). It can concurrently handle over 140,000 e-mails, 50,000 file transfers and over 250,000 web page requests a day.

The apparatus 200 contains web sites, e-mail, file sharing, discussion groups, muti-media contents, text indexing and retrieving. It has variety of system memory upgrades capability for 2 GB/4 GB/8 GB/16 GB or higher of Flash memories 201; and 32 MB/64 MB/128 MB/256 MB or higher of RAM memories 208.

### Apllications Compatibility

Application and Database plug-ins exists for the apparatus to easily integrate with the respective application providers.

### Web Page HTTP Authoring and Web Site Construction

Apparatus suite also works with Web Page Authoring programs such as Microsoft's FrontPage, FrontPage Server Extensions and WebDAV. WebDAV is a set of extensions to the HTTP protocol that allows users to collaboratively edit and manage files on remote web servers. This turns the web into a writable medium and is an alternative to file servers for the storage of dynamic documents.

### Automated DNS Zone Management

When apparatus 101 is hot-plugged into one of the ports (USB 10, CF 20, SDIO 30, PCI/PCI-Express 40, Cardbus 50, and ExpressCard 60), the apparatus' zone file information shall be updated automatically to its registered DNS server using existed host internet connection. Once the DNS update is completed, the apparatus 101 is ready for dedicated hosting services.

The apparatus 200 contains a processor 215 that is a highly integrated system on a chip and includes a high-performance low-power CPU 207 with a variety of different system peripherals.

What is claimed is:

1. An apparatus comprising: 1) a communication port utilized when said apparatus is operating as a Plug-and-Play web hosing device; 2) a processor that is highly integrated System on a Chip (SoC) and includes a high-performance low-power Central Processing Unit (CPU); 3) a companion Integrated Circuits (IC) chip that interfaces between CPU and said communication port capable of converting signals at said communication port to a protocol utilized by said device.

2. An apparatus of claim 1 and further including: a Micro-architecture that includes the on-chip 16-bit, 32-bit or 64-bit ROM/SRAM/SDRAM/FLASH memory, MIPS, ARM CPU core, DMA controller, and Memory controller.

3. An Apparatus of claim 1 and further including: a custom Apache-based Web server code is for integration with Linux/GNU that turns the apparatus into a Plug-and-Play Web Hosting device, capable of serving multiple clients at the same time.

4. An apparatus of claim 1 and further including: a non-Apache Web server code is for integration with Linux/GNU that turns the apparatus into a Plug-and-Play Web Hosting device, capable of serving multiple clients at the same time.

5. An Apparatus, of claim 1 and further including: a graphical user interface application, Web-Based Control Panel (WBCP), is for system administrator to create separate user accounts, security for restricted access and configuring the apparatus. When said apparatus is plugged in either one of the computer peripheral ports (USB, CF, SDIO, Cardbus, PCI/PCI-Express, ExpressCard or Ethernet), the WBCP application shall be popped up on the computer's screen and is ready for system administration tasks.

6. An apparatus of claim 1 and further including: a Shared Panel Application (SPA) program capable of drag-and-drop files between said apparatus and host computer, Windows or Macintosh operation systems.

7. An apparatus of claim 1 and further including: A Linux/GNU operating system, ported to the MIPS/ARM CPUs.

8. An apparatus of claim 1 and further including: a Router Code is for generally configuring and directing Internet traffics to and from said apparatus using existed internet connection of host computing device.

9. An apparatus of claim 1 and further including: a Universal Serial Bus (USB) port utilized when said apparatus is operating as an USB Plug-and-Play web hosting device.

10. An apparatus of claim 1 and further including: a Secure Digital Input and Output (SDIO) port utilized when said apparatus is operating as an SDIO Plug-and-Play web hosting device.

11. An apparatus of claim 1 and further including: a Compact Flash (CF) port utilized when said apparatus is operating as a CF web hosting device.

12. An apparatus of claim 1 and further including: a Cardbus port utilized when said apparatus is operating as a Cardbus web hosting device.

13. An apparatus of claim 1 and further including: a Peripheral Component Interconnect (PCI) port utilized when said apparatus is operating as a PCI web hosting device.

14. An apparatus of claim 1 and further including: a Peripheral Component Interconnect Express (PCI-Express) port utilized when said apparatus is operating as a PCI-Express web hosting device.

15. An apparatus of claim 1 and further including: an ExpressCard port utilized when said apparatus is operating as an ExpressCard Plug-and-Play web hosting device.

16. An apparatus of claim 1 and further including: A fast infrared communications port utilized when said apparatus is operating as to upload and download data to and from said apparatus.

17. An apparatus of claim 1 and further including: A tiny camera utilized when said apparatus is operating to capture still image, video clips, and recording video for applications such as: two ways video conferences, live presentations, and lives classroom lectures and trainings.

18. An apparatus of claim 1 and further including: a WiMax Transceiver module utilized when said apparatus is operating to transmit and receive internet traffics over the air.

19. An apparatus of claim 1 and further including: an Ultra Wide Band (UWB) Transceiver module utilized when said apparatus is operating to transmit and receive internet traffics over the air.

20. An apparatus of claim 1 and further including: a Code Division Multiple Access (CDMA) Transceiver module utilized when said apparatus is operating to transmit and receive internet traffics over the air.

21. An apparatus of claim 1 and further including: a Global System for Mobile Communication (GSM) Transceiver module utilized when said apparatus is operating to transmit and receive internet traffics over the air.

22. An apparatus of claim 1 and further including: a General Package Radio Service (GPRS) Transceiver module utilized when said apparatus is operating to transmit and receive internet traffics over the air.

23. An apparatus of claim 1 and further including: a Wideband Code Division Multiple Access (WCDMA) Transceiver module utilized when said apparatus is operating to transmit and receive internet traffics over the air.

24. An apparatus of claim 1 and further including: a tiny microphone utilized when said apparatus is operating to record audio.

25. An apparatus of claim 1 and further including: a tiny speaker utilized when said apparatus is operating to playback audio.
